(19) United States
(12) Patent Application Publication
(10) Pub. No.: US 2017/0309137 A1
(43) Pub. Date: Oct. 26, 2017

(54) DIRECT PROVISIONING OF ELECTRONIC TRANSACTION DATA

(71) Applicant: NCR Corporation, Duluth, GA (US)

(72) Inventors: Utkal Shah, Telangana (IN); Rupesh Durairaj, Telengana (IN); Mitesh G. Gajjar, Telangana (IN); Mario Noronha, Telengana (IN)

(21) Appl. No.: 15/137,322

(22) Filed: Apr. 25, 2016

(51) Int. Cl. G07G 1/01; H04L 29/08; G06Q 20/20

(52) U.S. Cl. CPC G07G 1/01; G06Q 20/209; H04L 67/104

(57) ABSTRACT

Various embodiments herein each include at least one of systems, methods, and devices for direct provisioning of electronic transaction data. For example, some embodiments include electronically transmitting a bill or receipt for goods or services of a purchase transaction via a wireless connection between a Point-Of-Sale (POS) device and a customer device. One method embodiment includes receiving input within a POS device to output a receipt of a transaction via a wireless transceiver device via a wireless peer-to-peer connection to a customer device and generating a receipt image from data of the transaction. This method then transmits the receipt image via the radio transceiver device of the POS device directly to the customer device via a wireless peer-to-peer connection.

### BACKGROUND INFORMATION

In modern retail and dining outlets, transactions are now being conducted on mobile devices, such as handheld computing devices, smartphones, smartwatches, tablets, and the like. Products to be purchased are entered thereon either manually, scanning, and the like, payment information is provided, and the transaction is completed. Customer receipts for such transactions may be printed by a carried printer, at a remote printer requiring retrieval, or emailed to the customer. Each of these receipt provisioning examples involve inefficiencies.

### SUMMARY

Various embodiments herein each include at least one of systems, methods, and devices for direct provisioning of electronic transaction data. For example, some embodiments include electronically transmitting a bill or receipt for goods or services of a purchase transaction via a wireless connection between a Point-Of-Sale (POS) device and a customer device.

One such embodiment, in the form of a method includes presenting a transaction on a display of a transaction processing device with an option to close the transaction and receiving close transaction input on the transaction processing device. This method further includes presenting an option to output a receipt of the transaction directly to a customer mobile device and receiving input to output the receipt of the transaction from the transaction processing device directly to the customer mobile device. In such embodiments, the method then transmits the receipt via a radio transceiver device of the transaction processing device to the customer mobile device directly in a peer-to-peer manner.

Another method embodiment includes receiving input within a POS device to output a receipt of a transaction via a wireless transceiver device via a wireless peer-to-peer connection to a customer device and generating a receipt image from data of the transaction. This method then transmits the receipt image via the radio transceiver device of the POS device directly to the customer device via a wireless peer-to-peer connection.

Another embodiment is in the form of a POS terminal. The POS terminal includes a radio transceiver device, at least one display device, at least one processor, and at least one memory device. The POS device further includes a transaction module including instructions stored in the at least one memory device that are executable by the at least one processor to perform data processing activities. In some embodiments, the data processing activities include presenting at least a portion of transaction information on the display device with an option to close the transaction and receiving close transaction input with regard to the close transaction option. The data processing activities further include presenting an option to output a receipt of the transaction directly to a customer mobile device and receiving input to output the receipt of the transaction from the POS terminal directly to the customer mobile device. The data processing activities may then be further executed to transmit the receipt via the radio transceiver device of the POS terminal to the customer mobile device directly in a peer-to-peer manner.

### BRIEF DESCRIPTION OF THE DRAWINGS

FIG. 1 is a logical block diagram of a system architecture, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, methods, and devices for direct provisioning of electronic transaction data. For example, some embodiments include electronically transmitting a bill or receipt for goods or services of a purchase transaction via a wireless connection between a Point-Of-Sale (POS) device and a customer device. The POS device may be a cash register, a mobile device carried by retail or restaurant outlet personnel, and the like. The customer device may be a mobile device, such as a smartphone, smartwatch, tablet, and the like. The wireless connection over which the bill or receipt is transmitted may be a Near Field Communication (NFC), BLUETOOTH®, peer-to-peer WI-FI®, infrared, or other wireless data interchange technologies, devices, and protocols. The bill or receipt may be transmitted via the wireless connection in the form of an image, a dataset structured according to a defined standard, or otherwise. Once the data of a bill or receipt is present on the customer mobile device, the bill or receipt data may be viewed thereon.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

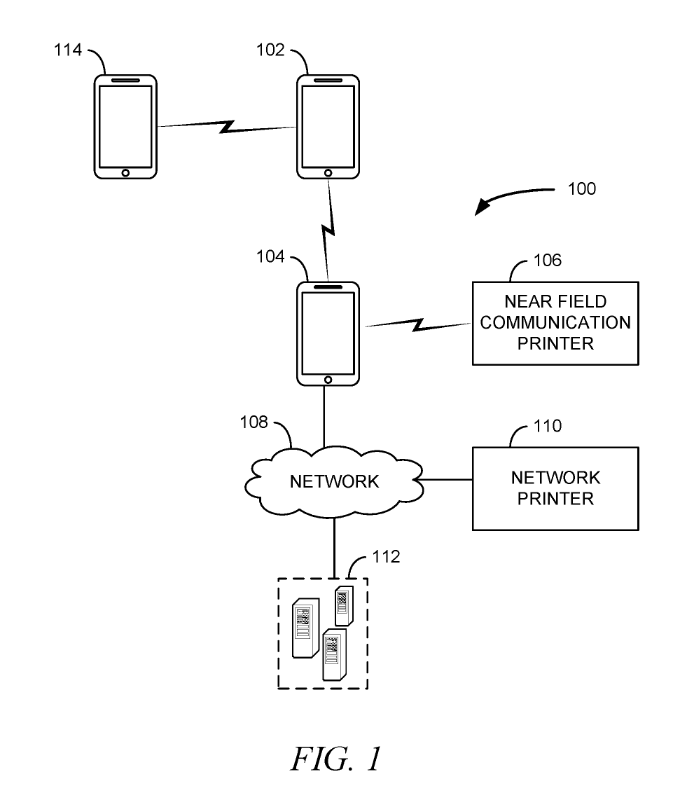

FIG. 1 is a logical block diagram of a system 100 architecture, according to an example embodiment. The system 100 includes a customer mobile device 102, a POS device 104, a network 108, and at least one backend system 112. The system 100 may further include a Near Field Communication (NFC) printer 106, a network printer 110, and a mobile device 114 of another customer or other individual.

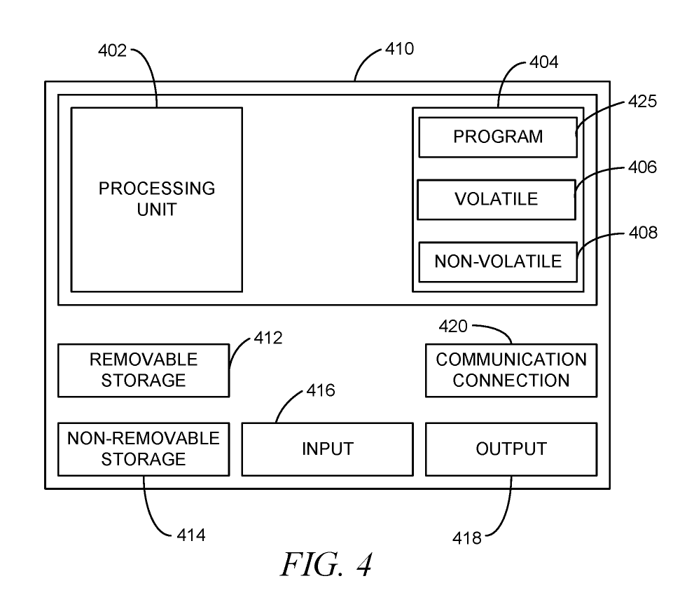

The customer mobile device 102 may be a smartphone, a smartwatch, a tablet, another type of handheld or wearable computing device, a laptop computer, and the like. The customer mobile device 102 includes various devices and elements therein, such as illustrated and described with regard to FIG. 4. In some embodiments, the customer mobile device 102 includes a short-range radio transceiver device, such as an NFC, BLUETOOTH, or other such radio transceiver device that enables the customer mobile device 102 to directly exchange data with other devices including such a radio transceiver device, such as the POS terminal 104 or the other mobile device 114, without another wireless or wired device relaying data there between. Note that in some embodiments, the radio transceiver device may be a WI-FI® device that may be utilized to establish peer-to-peer WI-FI® connectivity to allow for direct data exchange between the two devices.

The POS terminal 104 may be a mobile device on which software is present to enable conducting of purchase transactions thereon. In other embodiments, the POS terminal 104 may be a teller or self-service checkout terminal or kiosk. Regardless, the POS terminal 104 also includes a short-range radio transceiver device such as an NFC, BLUETOOTH, or other such radio transceiver device that enables the POS terminal 104 to directly exchange data with other devices including such a radio transceiver device, such as the customer mobile device 102, without another wireless or wired device relaying data there between. Note that in some embodiments, the radio transceiver device may be a WI-FI® device that may be utilized to establish peer-to-peer WI-FI® connectivity to allow for direct data exchange between the two devices. The POS terminal 104 may also communicate over the network 108 with one or more other systems, such as backend system 112.

In operation, a customer of the customer mobile device 102 is present at a retail or restaurant location and desires to procure goods or services. The goods or services to be procured are entered on the POS terminal 104 or other POS terminal. The POS terminal 104 may operate independently of other computing devices or may communicate data with the backend system 112 continuously or at certain points during a transaction. Once all items to be procured by the customer are entered into a transaction, the POS terminal 104 is utilized to close the transaction and provide at least one of a bill, if so desired by the customer such as in a restaurant, and a receipt once payment has been tendered. The receipt may be generated on the POS terminal 104, by the backend system 112 at the request of the POS terminal 104, or as a combination thereof. Once the receipt is generated, it may be output in different ways. If the POS terminal 104 includes an integrated or directly connected printer, the receipt or bill can simply be printed. The receipt may be output by sending the receipt over the network 108 to the network printer 110. The receipt may also be transmitted via the radio transceiver device of the POS terminal 104 to a printer also including such a radio transceiver device, such as the NFC printer 106. The POS terminal 104 may also output the receipt directly to the customer mobile device 102 via the radio transceiver device. The receipt, when generated, may be generated as an image, a dataset structured according to a proprietary or industry standard, or otherwise. The form that the receipt or bill is generated in may be dependent upon input received by the POS terminal 104 regarding a customer preference mode for receiving the bill or receipt.

Once the receipt or bill is present on the customer mobile device 102, the bill or receipt may then be transferred by the customer to other customers, or other individuals (e.g., a spouse, accounting department staff, etc.) directly via the radio transceiver devices of their respective mobile devices 102, 114.

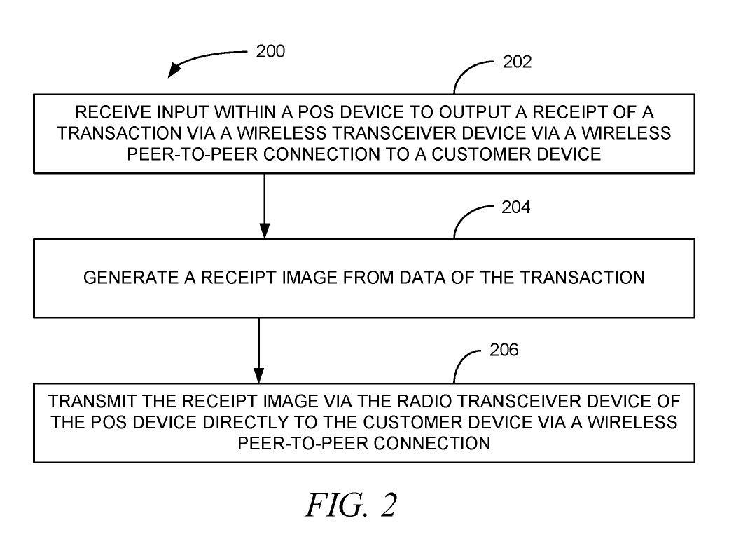

FIG. 2 is a block flow diagram of a method 200, according to an example embodiment. The method 200 is an example of a method that may be performed by a POS terminal, such as a mobile device on which POS software executes or an assisted or self-service POS terminal.

The method 200 include receiving 202 input within a POS device to output a receipt of a transaction via a wireless transceiver device, such as an NFC, BLUETOOTH®, or WI-FI® device, via a wireless peer-to-peer connection to a customer device. The method 200 then generates 204 a receipt image from data of the transaction and transmits 206 the receipt image via the radio transceiver device of the POS device directly to the customer device via a wireless peer-to-peer connection.

In some embodiments of the method 200, generating 204 the image of the receipt includes requesting a receipt image via a network from a receipt image generating process and receiving the image of the receipt via the network.

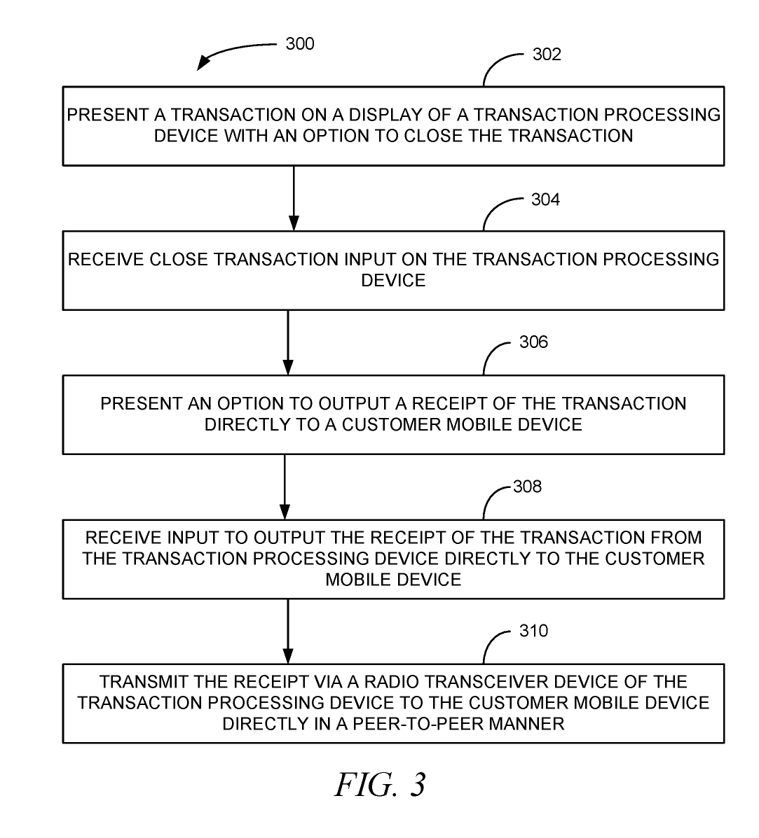

FIG. 3 is a block flow diagram of a method 300, according to an example embodiment. The method 300 is another example of a method that may be performed by a POS terminal, such as a mobile device on which POS software executes or an assisted or self-service POS terminal.

Some embodiments of the method 300 include presenting 302 a transaction on a display of a transaction processing device with an option to close the transaction and receiving 304 close transaction input on the transaction processing device. The presented 302 option and the received 304 input may be presented and received on a touch-screen device of a mobile device or other computing device on which the method 300 is implemented. However, in other embodiments, the presenting may be performed via another type of display and input received via another input device or mode depending on the type of computing device on which the method 300 is implemented and types display and input devices integrated therein or coupled thereto.

The method 300 further includes presenting 306 an option to output a receipt of the transaction directly to a customer mobile device and receiving 308 input to output the receipt of the transaction from the transaction processing device directly to the customer mobile device. The method 300 may then transmit 310 the receipt via a radio transceiver device of the transaction processing device to the customer mobile device directly in a peer-to-peer manner, such as via NFC, BLUETOOTH®, peer-to-peer WI-FI®, or other such data interconnection options and technologies.

In some embodiments, the method 300 further includes generating an image of the receipt and the transmitting 310 of the receipt to the customer mobile device includes transmitting 310 the image of the receipt. In some such embodiments, generating the image of the receipt includes requesting a receipt image via a network from a receipt image generating process and receiving the image of the receipt via the network in response thereto.

In some other embodiments of the method 300, presenting 306 the option to output the receipt of the transaction directly to the customer mobile device further includes presenting an option to output the receipt via a printer. The printer in such embodiments may be an NFC, BLUETOOTH®, or other printer that can be connected to via a peer-to-peer or networked connection.

In another embodiment of the method 300, presenting 306 the option to output the receipt of the transaction directly to the customer mobile device further includes presenting an option to output the receipt in a text message. In one such embodiment, upon receiving input to output the receipt in a text message, the method 300 further includes receiving input data indicating to where the text message including the receipt is to be transmitted, such as a phone number or other identifier of a suitable address or identifier to where the text message is to be sent. The transmitting 310 of the receipt in such embodiments is then performed by generating and sending a text message from the POS terminal or via a text message gateway accessible to the POS terminal via a network according to the received input data.

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
presenting a transaction on a display of a transaction processing device with an option to close the transaction;
receiving close transaction input on the transaction processing device;
presenting an option to output a receipt of the transaction directly to a customer mobile device;
receiving input to output the receipt of the transaction from the transaction processing device directly to the customer mobile device; and
transmitting the receipt via a radio transceiver device of the transaction processing device to the customer mobile device directly in a peer-to-peer manner.

2. The method of claim 1, further comprising:
generating an image of the receipt; and
wherein transmitting the receipt to the customer mobile device includes transmitting the image of the receipt.

3. The method of claim 2, wherein generating the image of the receipt includes:
requesting a receipt image via a network from a receipt image generating process; and
receiving the image of the receipt.

4. The method of claim 1, wherein presenting the option to output the receipt of the transaction directly to the customer mobile device further includes presenting an option to output the receipt via a printer.

5. The method of claim 1, wherein the transaction processing device is a mobile device.

6. The method of claim 1, wherein the radio transceiver device of the transaction processing device is a Near Field Communication radio transceiver device.

7. The method of claim 1, wherein the radio transceiver device of the transaction processing device is a Bluetooth radio transceiver device.

8. The method of claim 1, wherein presenting the option to output the receipt of the transaction directly to the customer mobile device further includes presenting an option to output the receipt in a text message, wherein upon receiving input to output the receipt in a text message, the method further comprises:
receiving input data indicating to where the text message including the receipt is to be transmitted; and
transmitting the receipt in a text message according to the received input data.

9. A method comprising:
receiving input within a point-of-sale (POS) device to output a receipt of a transaction via a wireless transceiver device via a wireless peer-to-peer connection to a customer device;
generating a receipt image from data of the transaction; and
transmitting the receipt image via the radio transceiver device of the POS device directly to the customer device via a wireless peer-to-peer connection.

10. The method of claim 9, wherein generating the image of the receipt includes:
requesting a receipt image via a network from a receipt image generating process; and
receiving the image of the receipt.

11. The method of claim 9, wherein the POS device is a mobile device.

12. The method of claim 9, wherein the radio transceiver device of the POS device is a Near Field Communication radio transceiver device.

13. The method of claim 9, wherein the POS device is a self-service terminal.

14. A Point-of-Sale (POS) terminal comprising:
a radio transceiver device;
at least one display device;
at least one processor;
at least one memory device;
a transaction module including instructions stored in the at least one memory device that are executable by the at least one processor to perform data processing activities comprising:
presenting at least a portion of transaction information on the display device with an option to close the transaction;
receiving close transaction input with regard to the close transaction option;
presenting an option to output a receipt of the transaction directly to a customer mobile device;
receiving input to output the receipt of the transaction from the POS terminal directly to the customer mobile device; and
transmitting the receipt via the radio transceiver device of the POS terminal to the customer mobile device directly in a peer-to-peer manner.

15. The POS terminal of claim 14, wherein the POS terminal is a mobile device.

16. The POS terminal of claim 14, further comprising:
a wireless network interface device; and
wherein the transaction module includes further instructions executable by the at least one processor to perform further data processing activities comprising:
receiving input with regard to a product to be purchased within the transaction;
receiving payment input to pay for one or more products to be purchased within the transaction;
transmitting data, via the at least one wireless network interface device, with regard to the one or more products to be purchased and the payment input received within the transaction; and
receiving data, via the at least one wireless network interface device, indicating the payment for the one or more products within the transaction has been successfully processed.

17. The POS terminal of claim 14, wherein the radio transceiver device is a Near Field Communication radio transceiver device.

18. The POS terminal of claim 14, wherein the POS terminal is a self-service POS terminal.

19. The POS terminal of claim 14, the data processing activities further comprising:
generating an image of the receipt for transmission to the customer mobile device.

20. The POS terminal of claim 19, further comprising:
a network interface device; and
wherein generating the image of the receipt includes:
requesting, over a network via the network interface device, the receipt image from a receipt image generating process that executes on a remote computing device; and
receiving, via the network interface device, the receipt image.
